(19) United States
(12) Patent Application Publication
(10) Pub. No.: US 2019/0299304 A1
(43) Pub. Date: Oct. 3, 2019

(54) SPECIAL END CUTTING EDGE ATTACHED CUTTER FOR CARBON FIBER REINFORCED POLYMER/PLASTIC WITH DESIGNABLE MICRO-TOOTH CONFIGURATION

(71) Applicant: Dalian University of Technology, Dalian City (CN)

(72) Inventors: Zhenyuan JIA, Dalian City (CN); Fuji WANG, Dalian City (CN); Zegang WANG, Dalian City (CN); Meng ZHAO, Dalian City (CN); Boyu ZHANG, Dalian City (CN); Yu BAI, Dalian City (CN)

(21) Appl. No.: 16/465,960

(22) PCT Filed: May 17, 2018
(86) PCT No.: PCT/CN2018/087193

§ 371 Date: May 31, 2019

(30) Foreign Application Priority Data
Sep. 11, 2017 (CN) 201710808999.6

(51) Int. Cl. B23C 5/18; B23C 5/10

(52) U.S. Cl. CPC B23C 5/18; B23C 2210/0485; B23C 2210/28; B23C 5/10

(57) ABSTRACT

A special end cutting edge attached cutter for carbon fiber reinforced polymer/plastic with designable micro-tooth configuration, having an end cutting edge, a peripheral cutting edge with variation inverse helical groove, a peripheral cutting edge with constant inverse helical groove and a shank. Two parallel V-shaped chip pockets are designed on the end cutting edge of the cutter in two cutting edge directions which are symmetrical around a cutter axis as a center. The structure may enhance chip removal performance during high-speed milling of impenetrable slots and impenetrable windows, reduce wear of the end cutting edge, conduct configuration design for micro-teeth of the peripheral cutting edge, reduce the cutting thickness of the micro-tooth cutting edges, and effectively solve the problem of damage of the micro-tooth edges. A section of peripheral cutting edge with variation left-hand inverse helical flute angle is designed near the end cutting edge.

### TECHNICAL FIELD

The present invention belongs to the technical field of milling tools in machining, and relates to a special end cutting edge attached cutter for carbon fiber reinforced polymer/plastic (CFRP) with designable micro-tooth configuration. Two parallel V-shaped chip pockets are designed on the end cutting edge of the cutter in two cutting edge directions which are symmetrical around a cutter axis as a center. The structure may enhance chip removal performance during high-speed milling of impenetrable slots and impenetrable windows, reduce wear of the end cutting edge, conduct configuration design for micro-teeth of the peripheral cutting edge, reduce the cutting thickness of the micro-tooth cutting edges, effectively solve the problem of damage of the micro-tooth edges and finally enhance the surface quality of window bottoms and slot bottoms and the service life of the cutter.

### BACKGROUND

Carbon fiber reinforced polymer/plastic (CFRP) has the performance advantages of high strength-to-weight ratio, fatigue resistance, corrosion resistance and strong bearing capacity compared with other metal materials. Therefore, the CFRP has become the preferred material for carrying equipment and weight reduction and efficiency improvement in the fields of aerospace and transportation. For CFRP members used in aerospace equipment, after laid, solidified and formed, in order to meet the requirements of assembly sizes, secondary processing is required. Especially, a large number of open impenetrable slots, open impenetrable windows and open special-shaped impenetrable holes are needed in members of engine pistons and aircraft wings. During high-speed milling processing of the impenetrable slots and the impenetrable windows, a closed space is formed; a cutting region has high temperature; removal is not smooth; and there are problems of serious wear of the end cutting edge of the cutter and easy corner chipping at an outlet and an inlet of the slots. The worn end cutting edge influences processing surface roughness, resulting in difficulty to ensure the quality of the processing surface of the slot bottom. Furthermore, the CFRP belongs to typical difficult-to-machine material wherein reinforced fibers and resin matrix have different linear expansion coefficients. The reinforced fibers are extremely easy to generate brittle fracture. The cutting edge continuously bears the loads of the matrix and the fibers. The loads are centralized on a small area near a cutting contact point. Especially during milling processing, instantaneous cutting thickness is varied, causing that the cutting force borne by the cutting edge fluctuates. If the strength of the cutting edge is insufficient, the cutting edge will be damaged, which will lead to poor processing surface quality and low cutter life. Especially, for the cutter with micro-tooth structure of peripheral cutting edge, micro-teeth are staggered in a certain rule. Micro-tooth configuration can determine overlaps of two adjacent micro-teeth. If the middle parts of adjacent micro-teeth are overlapped, and the edge parts of the micro-teeth are not overlapped, the cutting thickness of the edge part of the micro-teeth is larger than the cutting thickness of the middle parts of the micro-teeth, resulting in a large cutting force on the edge part. At the same time, because the cutting edge is sharp and low in strength, the edge part is more prone to damage. On the contrary, if the cutting edges are overlapped and the middle parts of the micro-teeth are not overlapped, the cutting thickness of the micro-tooth edge can be reduced, thereby effectively protecting the edge of micro-tooth. Therefore, in order to ensure long-term excellent cutting performance of the end cutting edge and the peripheral cutting edge in a complex cutting environment and to ensure the processing quality of the bottom surfaces and the side surfaces when milling the impenetrable windows and the impenetrable slots, it is of great significance to consider chip removal and heat dissipation performance of the end cutting edge and the micro-tooth configuration of the peripheral cutting edge for improving the quality of the processing surface and the life of the micro-tooth cutter.

A “carbide fish-scale type milling cutter” with patent application number of 200910013142.0 invented by Tang Chensheng et al. relates to a milling cutter for milling processing of composite materials such as carbon fibers and glass fibers. A left-hand flute and a right-hand flute are symmetrically staggered to form a cutting unit. The number of the cutting edges is increased to 24, which is equivalent, to a certain degree, to that the milling cutters with double edges and four edges improve cutting efficiency and processing quality and reduce the milling force. At the same time, in order to increase the cutting depth of micro-tooth cutting and increase the processing efficiency, a “multi-blade and micro-tooth milling cutter for high-speed milling of carbon fiber reinforced polymer/plastic (CFRP)” with a patent application number of 201610806761.5 invented by Wang Fuji et al. of Dalian University of Technology enhances the strength of a single micro-tooth by the design of a negative rake angle and a large minor cutting edge angle with the aid of the increase of the length of micro-tooth cutting edge. However, the traditional milling cutters mentioned in the above patents only have chip pockets between cutting edges in the end cutting edge, and are not designed with chip pockets at the end cutting edge axis. In the process of milling the structures of the impenetrable windows, the impenetrable slots and special-shaped impenetrable holes, the chips at the end cutting edge axis of the milling cutter are difficult to be removed due to small centrifugal force, and are extremely easy to concentrate on the end cutting edge axis and constantly wear the cutting edges, resulting in difficulty to ensure the processing quality of the bottom surface due to fast wear of the cutting edges. Therefore, the traditional milling cutters have certain limitations in the practical application of impenetrable slot and impenetrable window milling. Furthermore, the design of the micro-tooth milling cutters in the above invention patents does not consider the influence of micro-tooth configuration on damage of the cutting edges. If micro-tooth configuration is unreasonable, the micro-tooth edges will be easy to damage, thereby reducing the processing quality and the cutter life.

### SUMMARY

The present invention relates to a special end cutting edge attached cutter for carbon fiber reinforced polymer/plastic (CFRP) with designable micro-tooth configuration. Two parallel V-shaped chip pockets are designed on an end cutting edge of the cutter in two cutting edge directions which are symmetrical around a cutter axis as a center so as to solve the problem of chip aggregation caused by small centrifugal force at the end cutting edge axis of the traditional milling cutter when milling impenetrable slots and impenetrable windows; and special micro-tooth configuration design is considered for the peripheral cutting edge of the milling cutter so as to solve the problems of poor chip removal and heat dissipation at the end cutting edge, serious wear and corner chipping at the weak edge of the peripheral cutting edge of the micro-teeth when milling impenetrable slots and impenetrable windows at high speed by the CFRP, thereby enhancing the service life and the cutting performance of the cutter.

The technical solution of the present invention is:

To solve the problems of difficult chip removal and rapid wear of the end cutting edge, two parallel V-shaped chip pockets are designed on the end cutting edge of the cutter in two cutting edge directions which are symmetrical around a cutter axis as a center. The V-shaped chip pocket is connected and communicated with the chip pocket of the end cutting edge, so that the chips at the end cutting edge axis can be quickly and effectively removed when milling impenetrable slots and impenetrable windows at high speed and friction heat between the end cutting edge and the material is quickly radiated, to achieve the purpose of reducing wear of the end cutting edge.

A special end cutting edge attached cutter for CFRP with designable micro-tooth configuration comprises an end cutting edge I, a peripheral cutting edge II with variation inverse helical groove, a peripheral cutting edge III with constant inverse helical groove and a shank IV, wherein the end cutting edge I is designed with a rake face 2 of end cutting edge, a flank face 3 of end cutting edge, and a secondary flank face 4 of end cutting edge, and also has a chip pocket 5 of end cutting edge; and a primary cutting edge has a rake angle of 0°, a primary relief angle α_{f1} of 7° and a secondary relief angle α_{f2} of 14°.

Parallel V-shaped chip pockets 1 are designed on the end cutting edge I in two cutting edge directions which are symmetrical around a cutter axis as a center, and the V-shaped chip pocket 1 presents such a structural shape that a bottom is narrow and a top is wide, which is beneficial for quickly removing the chips of powdery CFRP. To ensure that the chip pocket of the end cutting edge has good chip removal performance and is closely connected with the chip pocket of the end cutting edge, the sizes of a design structure of the V-shaped chip pocket 1 are determined: the bottom width is L1, the top width of the V-shaped chip pocket is L2, the depth of the V-shaped chip pocket is L3 and tilt angles of two side surfaces of the V-shaped chip pocket 1 satisfy δ₁=δ₂.

The peripheral cutting edge II with variation inverse helical groove is of an asymmetric- and spiral-stagger structure, and m right-hand flutes 7 and n left-hand flutes 8 are staggered to form a plurality of equidimensional micro-teeth 6; to reduce the vibration of the end cutting edge I and a transition part of peripheral cutting edge during slot milling, a section of peripheral cutting edge II with variation left-hand inverse 8 helical flute angle is designed near the end cutting edge I; the peripheral cutting edge points to the end cutting edge direction and the change relationship of the helical angle of the left-hand flutes 8 is γ₁<γ₂<γ₃.

In view of the problem of corner chipping at the weak edge of micro-teeth, a design method for the micro-tooth configuration of the peripheral cutting edge of the cutter is invented. By determining the key structural parameters of the cutter and the geometrical relationship of the cutter structure, it is known from calculation that the micro-tooth edges are overlapped in forward and backward directions. The overlapping configuration mode of two micro-tooth edges can effectively reduce cutting thickness at the edges, thereby avoiding the phenomenon of easy corner chipping at the weak edges and realizing high-speed, steady and effective processing of the CFRP under large cutting amount. A three-dimensional stereographic cutter is sectioned along an axial direction and then is unfolded; the peripheral cutting edge III with constant inverse helical groove that represents the configuration mode is selected to form a two-dimensional schematic diagram of micro-tooth configuration of the cutter by using a tangential direction and an axial direction to form a coordinate system; the right-hand flutes 7 and the left-hand flutes 8 are staggered to form micro-teeth 6; the micro-teeth 6 comprise a lower cutting edge 9 and an upper cutting edge 10; in the design process of the cutter, tool geometric parameters are known, i.e., length A of the micro-tooth 6, width B of the right-hand flute 7, helical angle θ of the right-hand flute 7, number Z₁ of milling blade and milling cutter diameter D; the configuration mode of the micro-teeth 6 is mainly determined by the following variables: tangential length d of the left-hand flute 8, tangential length c between adjacent micro-teeth 6, helical angle β of the left-hand flute 7, tangential length f of micro-tooth 6, and number Z₂ of the left-hand flute 8; specific steps of the design method are as follows:

step 1: calculating the tangential length c between adjacent micro-teeth 6 through the milling cutter diameter D and the number Z₁ of milling blade;

$$c = \frac{π \times D}{{Z}_{1}} \qquad ( 1 )$$

step 2: selecting the tangential length d of the left-hand flute 8 as an independent variable parameter; establishing a triangle using the width B of the right-hand flute 7 and the tangential length d of the left-hand flute 8 as sides; and calculating the helical angle θ of the left-hand flute 8 through the geometrical relationship of the triangle;

$$\frac{sin ( θ + β )}{d} = \frac{cos β}{B} \qquad ( 2 )$$

similarly, establishing a triangle by using the length A of the micro-tooth 6 and the tangential length f of the micro-tooth 6 as side lengths; and calculating the tangential length f of the micro-tooth and the number Z₂ of left-hand flute through the geometrical relationship of the triangle;

$$\begin{matrix}\frac{sin ( θ + β )}{f} = \frac{cos β}{A} & ( 3 ) \\ f = ( π \times D \div {Z}_{2} ) - d & ( 4 )\end{matrix}$$

step 3: judging whether the relationship d<c<f is satisfied; if so, covering the lower cutting edge 9 and the upper cutting edge 10 of each micro-tooth 6 by the cutting edge of a previous micro-tooth 6 so that two edges of each micro-tooth 6 are overlapped; if not, returning to step 2 to reselect the tangential length d of inverse flute.

The present invention has beneficial effects that a special end cutting edge attached cutter for CFRP with designable micro-tooth configuration is invented. Two parallel V-shaped chip pockets are designed on the end cutting edge of the cutter in two cutting edge directions which are symmetrical around a cutter axis as a center. The chips and the heat at the end cutting edge axis can be rapidly removed in time during slot milling or impenetrable window milling, so as to avoid serious wear of the end cutting edge under the mixing effect of the chips and the heat and reduce the replacement time of the cutter, thereby enhancing surface processing quality and processing efficiency of the bottom of the chip pocket. When milling impenetrable windows and impenetrable slots of the CFRP, the overlapped configuration mode of two micro-tooth edges ensures that the previous micro-tooth always completes partial removal of the material before the material is removed from the micro-tooth edges. Therefore, this configuration mode can reduce the cutting thickness of the two micro-tooth edges, thereby reducing fracture of weak cutting edge and ensuring excellent cutting performance of the micro-teeth under a long cutting stroke and thus enhancing surface processing quality of side walls of the impenetrable slots and the impenetrable windows. The variation helical angle inverse flute chip with transition part from the peripheral cutting edge to the end cutting edge is adopted, which is a passive method to suppress vibration by means of disturbance regenerative chatter effect, which can effectively suppress chatter in high efficiency milling processing. High-quality and high-efficiency processing requirements for CFRP members with different fiber grades, different thicknesses and multiple lamination modes are satisfied.

### DESCRIPTION OF DRAWINGS

FIG. 1 is a structural schematic diagram of an end cutting edge attached cutter with designable micro-tooth configuration.

FIG. 2 is a left view of an end cutting edge attached cutter.

FIG. 3 is an enlarged view of an end cutting edge in FIG. 1.

FIG. 4 is a peripheral cutting edge with variation inverse helical groove.

FIG. 5 is a flow chart of calculation of overlapped configuration mode of two micro-tooth edges.

FIG. 6 is an expanded view of overlapped configuration mode of two micro-tooth edges.

FIG. 7(a) is a three-dimensional cutter of an embodiment 1.

FIG. 7(b) is a three-dimensional cutter of an embodiment 2.

FIG. 8(a) is wear of a cutter micro-tooth of overlapped configuration mode of two micro-tooth edges.

FIG. 8(b) is wear of a cutter micro-tooth without considering micro-tooth configuration mode.

In the figures: I end cutting edge; II peripheral cutting edge with variation inverse helical groove; III peripheral cutting edge with constant inverse helical groove; IV shank; 1 V-shaped chip pocket; 2 rake face of end cutting edge; 3 flank face of end cutting edge; 4 secondary flank face of end cutting edge; 5 chip pocket of end cutting edge; 6 micro-tooth; 7 right-hand flute; 8 left-hand flute; 9 lower cutting edge; 10 upper cutting edge; L1 bottom width of V-shaped chip pocket; L2 top width of V-shaped chip pocket; L3 depth of V-type chip pocket; L4 depth of chip pocket of end cutting edge; L5 length of peripheral cutting edge when inverse helical flute angle is γ₁; L6 length of peripheral cutting edge when inverse helical flute angle is γ₂; L7 length of peripheral cutting edge when inverse helical flute angle is γ₃; γ₁, γ₂ and γ₃ variation helical angles of variation left-hand inverse flute; α_{f1} primary relief angle of end cutting edge; α_{f2} secondary relief angle of end cutting edge; δ₁ left-side tilt angle of V-type chip pocket; δ₂ right-side tilt angle of V-type chip pocket; A length of micro-tooth; B width of left-hand flute; θ helical angle of right-hand flute; Z₁ number of milling blade; D milling cutter diameter; d tangential length of inverse flute; c tangential length between adjacent micro-teeth; β helical angle of left-hand flute; f tangential length of micro-tooth; and Z₂ number of flute.

### DETAILED DESCRIPTION

Specific embodiments of the present invention are further described below in combination with accompanying drawings and the technical solution.

### Optimal Embodiments

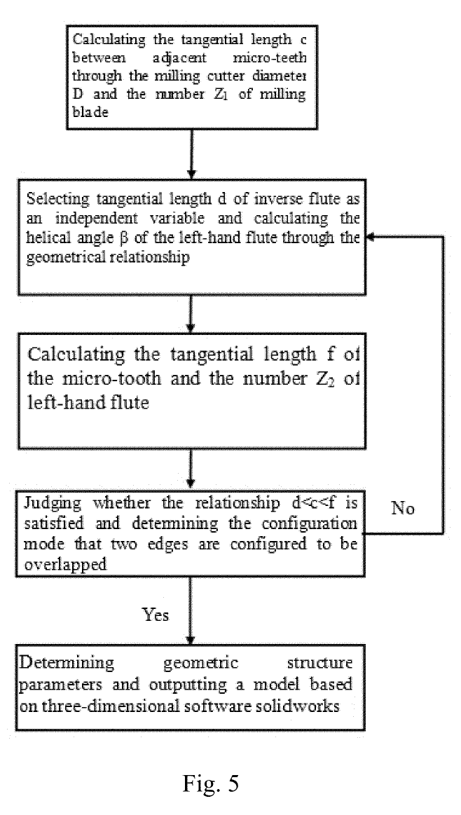

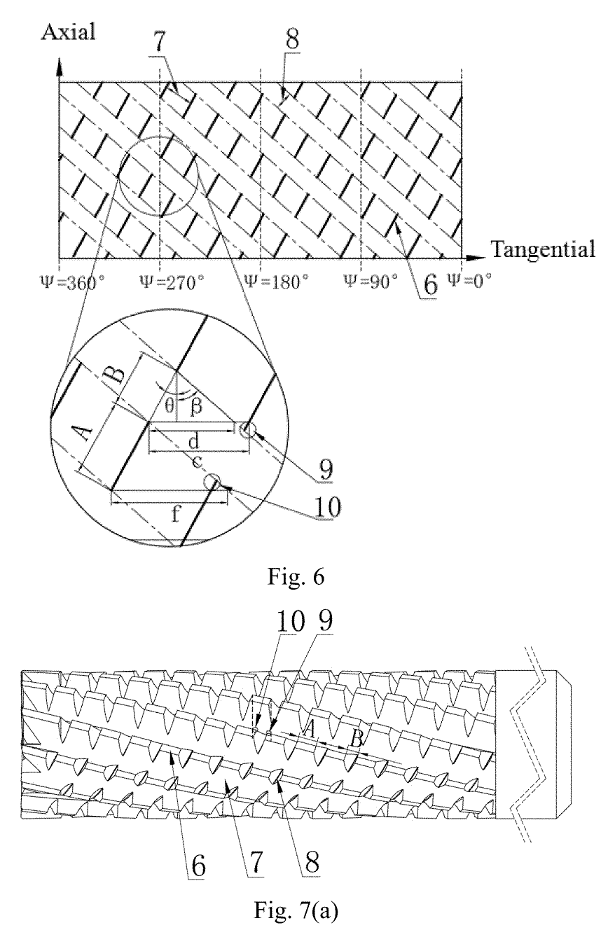

FIG. 2 is a structural schematic diagram of a V-shaped chip pocket protected in claim 1 of the present invention. FIG. 5 and FIG. 6 are design methods for micro-tooth configuration of the peripheral cutting edge of the milling cutter protected in claim 1 of the present invention. It can be seen from the drawings that the structure of the V-shaped chip pocket can smoothly remove the chips and the cutting heat from the bottom, so as to prevent the chips from being accumulated between the cutting edge and a processing surface and prevent serious wear of the end cutting edge. The design method for micro-tooth configuration ensures that the two micro-tooth edges are configured to be overlapped. This mode can effectively avoid the problem of corner chipping at the micro-tooth edges caused by large cutting thickness. The micro-teeth after corner chipping cannot effectively cut fibers and thus causes that the quality of the processing surface will not meet the requirements. Detailed description of the present invention is described below in detail in combination with accompanying drawings and the technical solution.

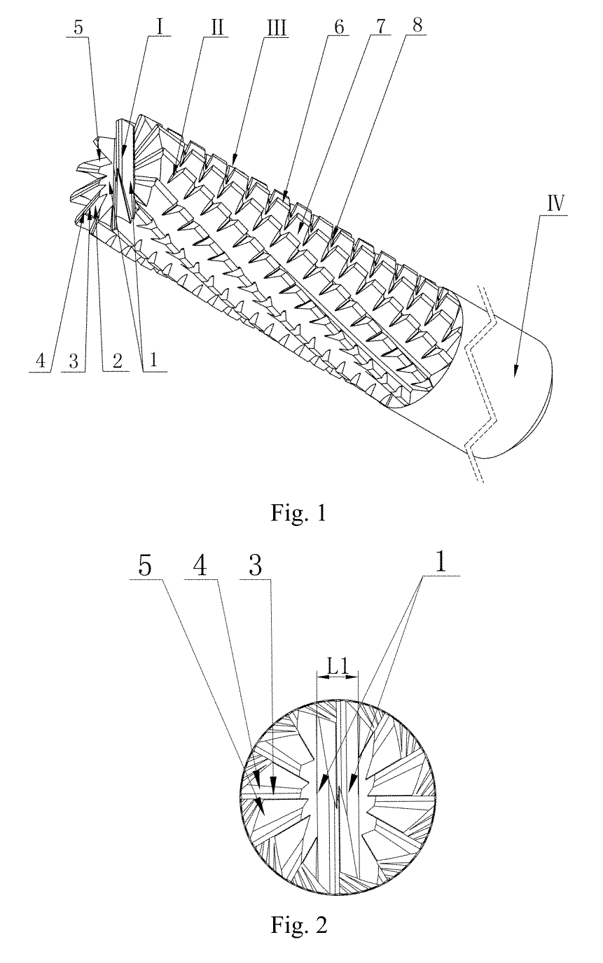

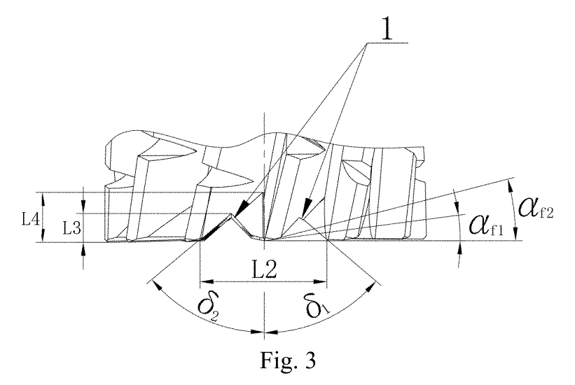

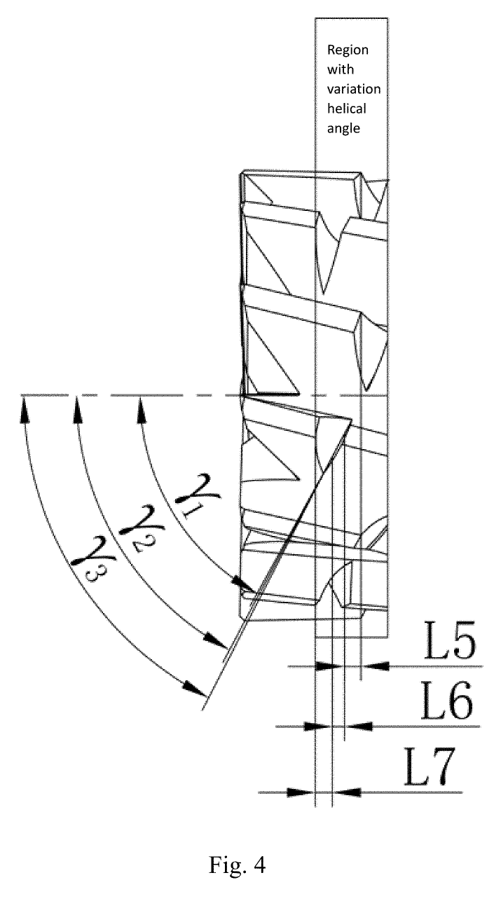

The end cutting edge attached cutter for high-speed CFRP milling in the present embodiment is shown in FIG. 1. The end cutting edge attached cutter comprises an end cutting edge I, a peripheral cutting edge II with variation inverse helical groove, a peripheral cutting edge III with constant inverse helical groove and a shank IV.

Two parallel V-shaped chip pockets 1 are designed on the end cutting edge I of the end cutting edge attached cutter in two cutting edge directions which are symmetrical around a cutter axis as a center. The bottom width of the V-shaped chip pocket 1 is L1=2.1 mm; the top width of the V-shaped chip pocket is L2=3.8 mm; the depth of the V-shaped chip pocket is L3=1.5 mm and tilt angles of two side surfaces of the V-shaped chip pocket 1 satisfy δ₁=δ₂=50°; a primary relief angle α_{f1} of the end cutting edge is 7°; and a secondary relief angle α_{f2} of the end cutting edge is 14°. The peripheral cutting edge II with variation inverse helical groove is of an asymmetric- and spiral-stagger structure. A section of peripheral cutting edge with variation helical angle is designed near the end cutting edge. The peripheral cutting edge points to the end cutting edge direction. When the helical angle of the left-hand flute 8 is γ₁=66.7°, a corresponding length of the peripheral cutting edge is L5=0.5 mm; when the helical angle of the flute 8 is γ₂=67.5°, a corresponding length of the peripheral cutting edge is L6=0.4 mm and when the helical angle of the flute 8 is γ₃=75.7°, a corresponding length of the peripheral cutting edge is L7=0.5 mm.

In the design of the cutter, considering reduction of burrs and axial force, basic tool geometric parameters are determined as follows: helical angle θ of the right-hand flute is 15°, length A of the micro-tooth 6 is 1.3 mm, width B of the flute is 0.8 mm, number Z₁ of milling blade is 12 and milling cutter diameter D is 10 mm; tangential lengths of inverse flute are respectively selected as follows: d₁=2 mm and d₂=2.3 mm; tangential length c between adjacent micro-teeth, helical angle β of the left-hand flute, tangential length f of micro-tooth and number Z₁ of the flute are determined; and several different configuration modes are analyzed. Specific steps of the design method are as follows:

step 1: calculating the tangential length c between adjacent micro-teeth as 2.618 mm through the milling cutter diameter D and the number Z₁ of milling blade in accordance with formula (1);

step 2: respectively selecting tangential lengths of inverse flute as follows: d₁=2 mm and d₂=2.3 mm; and in accordance with formulas (2), (3) and (4), respectively calculating β₁=66.7°, β₂=69.7°, f₁=3.25 mm, f₂=3.7375 mm, Z₂₁=6 and Z₂₂=5; and step 3: analyzing the micro-tooth configuration mode under different values of the tangential length d of inverse flute through the geometric parameters calculated in step 1 and step 2:

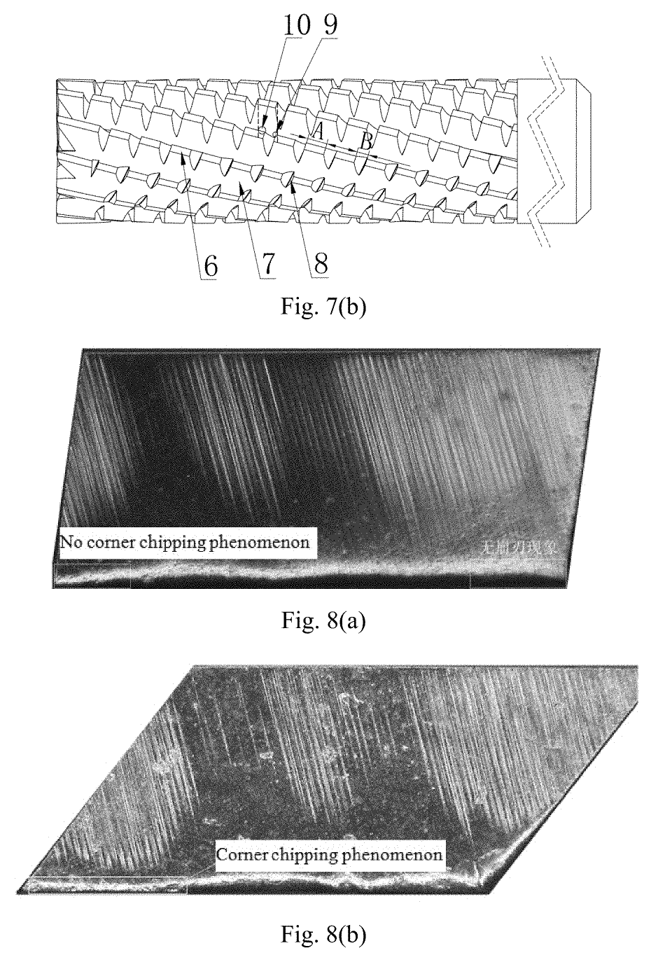

At this moment, d₁<c<f₁ and d₂<c<f₂ are satisfied. Such configuration mode that the upper cutting edge and the lower cutting edge of the micro-tooth are overlapped. Based on three-dimensional mapping software SolidWorks, two cutters can be designed, as shown in FIGS. 7(a) and (b), and each micro-tooth has a lower edge overlap 4 and an upper edge overlap 5.

To verify the application effect of the special end cutting edge attached cutter for CFRP which considers micro-tooth configuration design, when spindle speed is 6000 rpm and feed rate is 800 mm/min, the CFRP with a thickness of 8 mm is subjected to an impenetrable slot milling experiment. The experiment finds: in the milling process, there is no phenomenon of corner chipping at the micro-tooth edges of the peripheral cutting edge of the cutter which considers micro-tooth configuration design, as shown in FIG. 8(a); there is a phenomenon of corner chipping at the micro-tooth edges of the peripheral cutting edge of the cutter which does not consider micro-tooth configuration design, as shown in FIG. 8(b).

### INDUSTRIAL APPLICABILITY

The special end cutting edge attached cutter for CFRP with designable micro-tooth configuration in the present invention is especially suitable for milling processing of impenetrable slots, impenetrable windows and special-shaped impenetrable hole structures in CFRP members. The parallel V-shaped chip pockets are designed on the end cutting edge of the cutter in two cutting edge directions which are symmetrical around a cutter axis as a center, so as to effectively enhance the chip removal and heat radiation performance of the cutter, reduce the wear of the chips to the end cutting edge and ensure the processing quality of bottom surfaces of the impenetrable windows and the impenetrable slots. The peripheral cutting edge with variation inverse helical groove in the cutter can reduce cutting tool vibration during milling processing. Considering reasonable micro-tooth configuration of the peripheral cutting edge of the cutter may avoid the problem of corner chipping on two micro-tooth edges caused by large cutting thickness, thereby effectively protecting the edges with poor micro-tooth strength and ensuring that the micro-teeth of the peripheral cutting edge of the cutter have long-term excellent cutting performance. Therefore, the cutter of the present invention is intended to enhance the service life of the cutter with respect to the milling processing of the CFRP, and its industrial application not only can reduce tool change time and increase processing efficiency, but also can reduce the use cost and finally enhance economic benefits of enterprises.

1. A special end cutting edge attached cutter for carbon fiber reinforced polymer/plastic with designable micro-tooth configuration, wherein the special end cutting edge attached cutter with designable micro-tooth configuration for CFRP comprises an end cutting edge, a peripheral cutting edge with variation inverse helical groove, a peripheral cutting edge with constant inverse helical groove and a shank;
wherein the end cutting edge is designed with a rake face of end cutting edge, a flank face of end cutting edge, and a secondary flank face of end cutting edge, and also has a chip pocket of end cutting edge; parallel V-shaped chip pockets are designed on the end cutting edge in two cutting edge directions which are symmetrical around a cutter axis as a center, and the V-shaped chip pocket presents such a structural shape that a bottom is narrow and a top is wide; to ensure that the V-shaped chip pocket has good chip removal performance and is closely connected with the chip pocket of end cutting edge, the sizes of a design structure of the V-shaped chip pocket are determined: the bottom width is L1, the top width of V-shaped chip pocket is L2, the depth of the V-shaped chip pocket is L3 and tilt angles of two side surfaces of the V-shaped chip pocket satisfy δ₁=δ₂;
the peripheral cutting edge with variation inverse helical groove is of an asymmetric- and spiral-stagger structure, and m right-hand flutes and n left-hand flutes are staggered to form a plurality of equidimensional micro-teeth; to reduce the vibration of the end cutting edge and a transition part of peripheral cutting edge during slot milling, a section of peripheral cutting edge with variation left-hand inverse helical flute angle is designed near the end cutting edge; the peripheral cutting edge with variation left-hand inverse helical flute angle points to the end cutting edge direction and the change relationship of the helical angle of the left-hand flutes is γ₁<γ₂<γ₃;
a three-dimensional stereographic cutter is sectioned along an axial direction and then is unfolded; the peripheral cutting edge with constant inverse helical groove that represents the configuration mode is selected to form a two-dimensional schematic diagram of micro-tooth configuration of the cutter by using a tangential direction and an axial direction to form a coordinate system; the right-hand flutes and the left-hand flutes are staggered to form micro-teeth; the micro-teeth comprise a lower cutting edge and an upper cutting edge; in the design process of the cutter, tool geometric parameters are known, i.e., length A of the micro-tooth, width B of the right-hand flute, helical angle θ of the right-hand flute, number of milling blade Z₁ and milling cutter diameter D; the configuration mode of the micro-teeth is mainly determined by the following variables: tangential length d of the left-hand flute, tangential length c between adjacent micro-teeth, helical angle β of the left-hand flute, tangential length f of micro-tooth, and number Z₂ of the left-hand flute; specific steps of the design method are as follows:
step 1: calculating the tangential length c between adjacent micro-teeth through the milling cutter diameter D and the number Z₁ of milling blade;
$$c = \frac{n \times D}{{Z}_{1}} \qquad ( 1 )$$
step 2: selecting the tangential length d of the left-hand flute as an independent variable parameter; establishing a triangle using the width B of the right-hand flute and the tangential length d of the left-hand flute as sides; and calculating the helical angle β of the left-hand flute through the geometrical relationship of the triangle:
$$\frac{sin ( θ + β )}{d} = \frac{cos β}{B} \qquad ( 2 )$$
similarly, establishing a triangle by using the length A of the micro-tooth and the tangential length f of the micro-tooth as side lengths; and calculating the tangential length f of the micro-tooth and the number Z₂ of left-hand flute through the geometrical relationship of the triangle;
$$\begin{matrix}\frac{sin ( θ + β )}{f} = \frac{cos β}{A} & ( 3 ) \\ f = ( π \times D \div {Z}_{2} ) - d & ( 4 )\end{matrix}$$
step 3: judging whether the relationship d<c<f is satisfied; if so, covering the lower cutting edge and the upper cutting edge of each micro-tooth by the cutting edge of a previous micro-tooth so that two edges of each micro-tooth are overlapped; if not, returning to step 2 to reselect the tangential length d of inverse flute.
